(19) United States
(12) Patent Application Publication
(10) Pub. No.: US 2023/0308873 A1
(43) Pub. Date: Sep. 28, 2023

(54) SYSTEMS AND METHODS FOR USER AUTHENTICATED DEVICES

(71) Applicant: Apple Inc., Cupertino, CA (US)

(72) Inventors: Michael J. Oudenhoven, San Francisco, CA (US); Brian S. Lau, San Francisco, CA (US); David A. Kalinowski, Davis, CA (US)

(21) Appl. No.: 18/189,815

(22) Filed: Mar. 24, 2023

Related U.S. Application Data
(63) Continuation of application No. PCT/US2021/071472, filed on Sep. 15, 2021.
(60) Provisional application No. 63/083,569, filed on Sep. 25, 2020.

(51) Int. Cl. H04W 12/06; H04W 12/33; H04W 12/08; H04W 12/63; G06F 21/32

(52) U.S. Cl. CPC H04W 12/06; H04W 12/33; H04W 12/08; H04W 12/63; G06F 21/32

(57) ABSTRACT

A system for user authentication can include a wearable device configured to detect an orientation of user's gaze. The wearable device can determine whether the orientation of the user's gaze satisfies a condition based at least in part on the location of a companion device, and transfer information to the companion device in response to determining whether the orientation of the user's gaze satisfies the condition.

### CROSS-REFERENCE TO RELATED APPLICATION

This is a continuation of International Patent Application No. PCT/US2021/071472, filed 15 Sep. 2021, and entitled “SYSTEMS AND METHODS FOR USER AUTHENTICATED DEVICES,” which claims priority to U.S. Provisional Patent Application No. 63/083,569, filed 25 Sep. 2020, and entitled “SYSTEMS AND METHODS FOR USER AUTHENTICATED DEVICES,” the entire disclosures of which are hereby incorporated by reference.

### FIELD

The described embodiments relate generally to user authentication. More particularly, the present embodiments relate to user authentication for computing devices and wearable computing devices.

### BACKGROUND

Many electronic devices restrict access to various features and functions of the electronic device based on identity authentication of the user. When multiple devices are used concurrently, procedures for unlocking each device individually can delay user access and reduce the quality of the user experience. Further, use of one device may inhibit user authorization on a second device.

Electronic devices often include bio-authentication functionality through facial recognition, iris authentication and eye gaze tracking. In practice, facial recognition is often accomplished by using a structure light source to create a 3D contour map of the face. Similarly, eye tracking and iris authentication locate and track reflections placed on the cornea from an applied light source. Infrared is often used as the applied light source for facial recognition and eye tracking. However, if the user is wearing eyewear, such as sunglasses or a head-mounted device with infrared (IR) blockers or filters, then the infrared light reflections may be distorted or even blocked, thereby undesirably inhibiting facial recognition of the user for authentication purposes.

### SUMMARY

According to some aspects of the present disclosure, a system for user authentication can include a wearable device configured to detect an orientation of a gaze of a user, determine whether the orientation of the gaze satisfies a condition based at least in part on a location of a companion device, and transmit a signal to the companion device in response to determining that the orientation of the gaze satisfies the condition.

In some examples, the orientation of the gaze includes a direction the user is looking. The condition can include the orientation of the gaze being within one degree of the location of the companion device, and the signal can include authentication credentials to access the companion device. The companion device can have a locked state and an unlocked state. The signal can include authentication credentials to change the companion device from the locked state to the unlocked state.

In some examples, a restricted-access function of the companion device can be inaccessible by the user in the locked state, and the restricted-access function of the companion device can be accessible by the user in the unlocked state. The wearable device can include a camera configured to capture an image of the user's eye. The wearable device can determine whether the orientation of the gaze satisfies the condition based at least in part on the captured image. The camera can be a first camera and the wearable device can include a second camera configured to determine an orientation of the companion device. The wearable device can determine whether the orientation of the gaze satisfies the condition based at least in part on the orientation of the companion device. The wearable device can include a proximity sensor to detect the location of the companion device.

In some examples, the wearable device is configured to authenticate the user prior to transmitting the signal to the companion device. The companion device can include a facial recognition system configured to recognize a user's face, and the wearable device can be configured to detect the orientation of the gaze when the companion device recognizes the user's face. The wearable device can include a head-mounted device.

According to some aspects, a wearable device includes a user-facing camera configured to detect an eye pose of a user, a processor in communication with the user-facing camera, the processor configured to determine whether the user is looking at a proximate device based at least in part on the eye pose, and a transmission component in communication with the processor, the transmission component configured to transmit authentication credentials to the proximate device in response to determining that the user is looking at the proximate device.

In some examples, the wearable device includes an outward-facing camera configured to detect a location of the proximate device. The processor can be configured to determine whether a display of the proximate device is facing the user's eye, and provide a signal in response to determining that the user is looking at the proximate device and that the display of the proximate device is facing the user's eye. The wearable device can include a head-mounted device having an optical lens stack of one or more layers, including infrared blocking layers. The head-mounted device can include an infrared protective lens.

According to some aspects, a method for user authentication includes detecting a gaze direction of a user by a primary device, detecting a position of a secondary device, providing a signal from the primary device to the secondary device in response to determining that the gaze direction is oriented toward the position of the secondary device.

In some examples, detecting the position of the secondary device includes detecting an orientation of the secondary device. The signal can include authentication credentials. Detecting the position of the secondary device can include detecting that the secondary device is within a predetermined threshold distance from the primary device. The gaze direction can be determined to be oriented toward the position of the secondary device when the gaze direction is within one degree of any portion of the secondary device. Detecting the position of the secondary device can include displaying a symbol on the secondary device and detecting the symbol with the primary device.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows a block diagram of example electronic devices.

FIG. 2A shows a system for user authentication of electronic devices.

FIG. 2B shows a side view of a wearable device.

FIG. 2C shows a perspective view of a wearable device.

FIG. 2D shows a schematic diagram of a user authentication system.

FIG. 2E shows a schematic diagram of a user authentication system.

FIG. 3 shows a flow diagram on an example user authentication system.

FIG. 4 shows a flow diagram on an example user authentication system.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates to a wearable device enabled with eye tracking technology that enhances user authentication of a companion device under a wide range of circumstances and protocols.

Current electronic devices, such as smartphones, tablets, and laptops can include facial recognition functionality for user authentication. The orientation of a user's gaze can be tracked to ensure that the user is attentive and intending to unlock a particular device or perform a particular function. In practice, eye tracking for facial recognition is often accomplished by locating and tracking corneal reflections from an applied light source. Infrared or near-infrared light is not perceivable by the human eye and is therefore, often used as the applied light source for facial recognition and eye tracking.

Because facial recognition often utilizes infrared light, a challenge arises when a user is wearing eyewear, such as sunglasses or head-mounted devices that include infrared protective lenses having infrared (IR) blockers or filters. For example, the current state of the art gaze tracking systems for augmented reality (AR), virtual reality (VR), or mixed reality (MR) systems use IR illumination sources and IR cameras to track the pupil and glints on the cornea. Thus, the performance of gaze tracking systems in non-enclosed devices, such as AR devices, is challenging in outdoor scenarios due to external environmental light that can create false glints on the cornea or requires the system to have extreme dynamic range to differentiate between wanted and unwanted illumination sources. Thus, although including IR filters into lens stacks of head-mounted devices can be beneficial by helping to block undesired environmental IR light and protect the user's eyes, IR filters can also interfere with facial recognition protocols of a companion electronic device.

In a particular example, the present disclosure addresses the challenge resulting from a head-mounted device, such as smart glasses, partially or completely occluding a user's eyes with IR filters, and thereby preventing the user from unlocking a companion device, such as a smartphone, using facial recognition technology on the companion device. According to one example, the present disclosure addresses and overcomes these challenges by using an on-board vision system of the head-mounted device to determine, based on a location of the companion device and a gaze of the user, whether the user is looking at the companion device, and thus intending to unlock the device.

In an example operational sequence, a user wearing a head-mounted device with IR filters desires to unlock a companion device, such as a smartphone or tablet, using facial recognition. The user can orient the companion device such that a vision system of the companion device locates the user's face and begins a facial recognition sequence. Because the user's eyes are occluded by the IR filters, the companion device may be able to only complete a partial match of the user's face, insufficient to unlock the companion device. The head-mounted device and the companion device can exchange electronic communications or transmissions to prompt a vision system of the head-mounted device to determine or detect an orientation of a gaze of the user, for example, via a user-facing camera. The orientation of a gaze or gaze direction of the user can correspond to what the user is looking at or the line of sight of the user. In some examples, this can be referred to as the eye pose (e.g., a determination of the direction in which the eye is looking). The pose or orientation of the eye can be determined based on the positions of ocular characteristics, such as the pupil, iris, cornea, glints, and other ocular characteristics. The position of the ocular characteristics can be determined relative to the head-mounted device, the eyelids or face of the user, or relative to the natural static direction of the eye. Further, the vision system of the head-mounted device and/or of the companion device can determine or detect a location of the companion device relative to the head-mounted device, for example, with a second, outward-facing camera. In some examples, a single camera can both detect the orientation of the user's gaze and the location of the companion device. Once a gaze direction or orientation of the user and a relative location of the companion device are determined, the system can determine whether the user is looking at the companion device. That is, the system can determine whether the orientation of the user's gaze satisfies a condition based in part on the location of the companion device. The condition satisfied by the orientation of the user's gaze can be that the user's gaze is directed at the companion device. In some examples, the condition can thus be based at least in part on a location of the companion or proximate device. In some examples, the condition is satisfied if the gaze direction is oriented toward the position of the companion device. In some examples, the orientation of the gaze satisfies the condition when the orientation of the user's gaze is within a predetermined degree threshold of the location of a display of the proximate or companion device. For example, if the orientation of the gaze is within 5 degrees of any portion of the companion device. In some examples, it is determined that the user is looking at the companion device if the orientation of the gaze is within 1 degree of any portion of the companion device.

If it is determined that the user is looking at the companion device, the head-mounted device can transmit a signal to the companion device. The signal can contain informational data. For example, the head-mounted device can provide authentication credentials to unlock the companion device. It will be understood that an operational sequence can include other features not discussed in the above example, such as those discussed below.

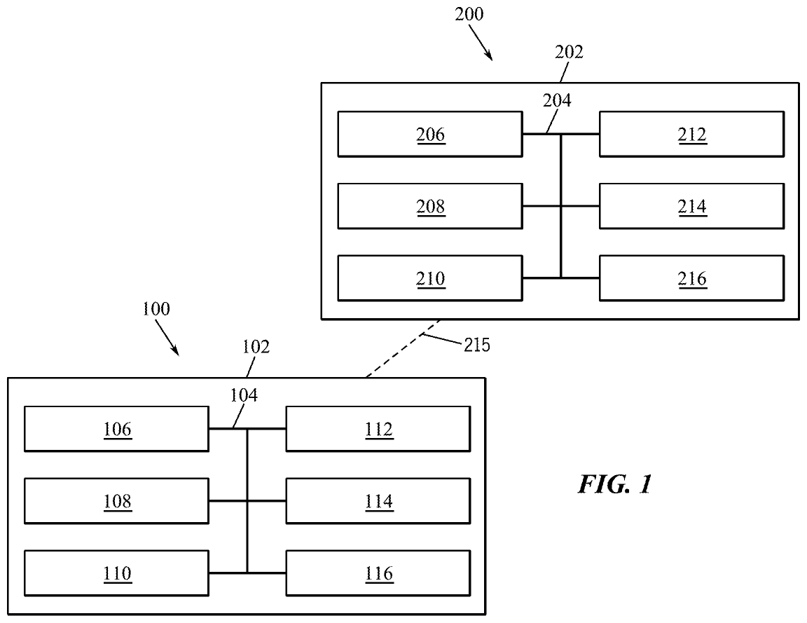

These and other embodiments are discussed below with reference to FIGS. 1-4. However, those skilled in the art will readily appreciate that the detailed description given herein with respect to these Figures is for explanatory purposes only and should not be construed as limiting.

FIG. 1 shows a block diagram of example electronic devices 100 and 200. The electronic device 100 can be a wearable device, such as a head-mounted device. In some example, the wearable device 100 can be a head-mounted device for use in virtual reality, mixed reality, augmented reality, augmented virtuality, or computer-generated reality. The wearable device 100 can include a housing 102, an internal signal distribution medium 104, a power supply unit 106, a data storage unit 108, a data processing unit 110, a sensor unit 112, an electronic communication unit 114, and a human interface unit 116. The wearable device 100 can implement one or more aspects of the methods and systems described herein. It will be understood that the wearable device 100 can include other components not shown in FIG. 1.

The housing 102 can be a physical structure that incorporates, contains, or connects to the internal signal distribution medium 104, the power supply unit 106, the data storage unit 108, the data processing unit 110, the sensor unit 112, the electronic communication unit 114, and the human interface unit 116. In some examples, one or more of the internal signal distribution medium 104, the power supply unit 106, the data storage unit 108, the data processing unit 110, the sensor unit 112, the electronic communication unit 114, or the human interface unit 116 can be omitted. Although FIG. 1 shows the housing 102 as a single unit, multiple operatively connected housing units can be used.

The internal signal distribution medium 104 can be operatively coupled to the power supply unit 106, the data storage unit 108, the data processing unit 110, the sensor unit 112, the electronic communication unit 114, and the human interface unit 116. The internal signal distribution medium 104 can operate to carry or distribute internal data signals, power signals, or both. In some examples, the internal signal distribution medium 104 can include a distinct power distribution component and a distinct data signal distribution component. Although FIG. 1 shows the internal signal distribution medium 104 as a single unit, multiple internal signal distribution mediums can be used.

The power supply unit 106 can be operative to supply power to the internal signal distribution medium 104, the data storage unit 108, the data processing unit 110, the sensor unit 112, the electronic communication unit 114, and the human interface unit 116, such as via the internal signal distribution medium 104. The power supply unit 106 can be a battery, a power scavenging unit, an interface with an external, wired or wireless, power source, or a combination thereof. Although FIG. 1 shows the power supply unit 106 as a single unit, multiple power supply units can be used.

The data storage unit 108 can be operable to store and retrieve data, which may include computer program instructions and other data. Although FIG. 1 shows the data storage unit 108 as a single unit, multiple data storage units 108 can be used. For example, the data storage unit 108 can include volatile memory, such as one or more random-access memory units, operable to provide storage and retrieval of an operative data set during active operation of the electronic device 100, and the data storage unit 108 can include persistent memory, such as a hard-drive, operable to provide storage and retrieval of data during active operation and to provide storage of data in an inactive, powered down, state.

The data processing unit 110, or processor, is operable to receive data, such as from the data storage unit 108, the sensor unit 112, the electronic communication unit 114, the human interface unit 116, or a combination thereof. The data processing unit 110 is operable to perform or execute computer program instructions, such as based on the received data. For example. The data processing unit 110 can be operable to receive and execute the computer program instructions stored on the data storage unit 108. The data processing unit 110 is operable to output data. For example, the data processing unit 110 may output data to the data storage unit 108, the sensor unit 112, the electronic communication unit 114, the human interface unit 116, or a combination thereof. The data processing unit 110 is operable to control the internal signal distribution medium 104, the power supply unit 106, the data storage unit 108, the sensor unit 112, the electronic communication unit 114, the human interface unit 116, or a combination thereof. Although FIG. 1 shows the data processing unit 110 as a single unit, multiple data processing units can be used.

The sensor unit 112 can detect or determine one or more aspects of the operational environment or physical environment of the electronic device 100. Although only one sensor unit 112 is shown in FIG. 1, it will be understood that sensor unit 112 can include multiple physically distinct or combined sensors. For example, sensor unit 112 can include one or more of a camera, a microphone, an infrared receiver, a global positioning system unit, a gyroscopic sensor, an accelerometer, a pressure sensor, a capacitive sensor, a biometric sensor, a magnetometer, a radar unit, a LIDAR unit, an ultrasound unit, a temperature sensor, or any other sensor capable of detecting or determining one or more aspects or conditions of the operational environment of the electronic device for computing and communication 100.

The electronic communication unit or transmission component 114 can include a transmitter, such as one or more wireless antennas that can receive and/or transmit signals. The electronic communication or transmission component 114 can communicate data (i.e., receive and transmit a signal) with one or more external devices or systems, such as companion device 200, using one or more wired or wireless electronic communication protocols, such as an 802.11 electronic communication protocol, a Bluetooth electronic communication protocol, a near-field communication (NFC) electronic communication protocol, an infrared (IR) electronic communication protocol, a human-body-conductivity electronic communication protocol, a light modulation electronic communication protocol, a sound modulation electronic communication protocol, a power modulation electronic communication protocol, or the like. Thus, the electronic communication unit 114 can include one or more wireless antennas that can receive and/or transmit signals through any of the protocols discussed herein. Although FIG. 1 shows the electronic communication unit 114 as a single unit, multiple electronic communication units can be used.

The human interface unit 116, or user interface, can be operative to output, present, or display data to a user of the electronic device for computing and communication 100, such as data received from the internal signal distribution medium 104, the power supply unit 106, the data storage unit 108, the data processing unit 110, the sensor unit 112, the electronic communication unit 114, or a combination thereof. For example, the human interface unit 116 can include a light-based display, a sound-based display, a haptic feedback system, a motion-based display, or a combination thereof.

The human interface unit 116, can be operative to receive user input and to communicate user input data representing the user input to the internal signal distribution medium 104, the power supply unit 106, the data storage unit 108, the data processing unit 110, the sensor unit 112, the electronic communication unit 114, or a combination thereof. In some examples, the human interface unit 116 can receive one or more signals from the sensor unit 112 and can interpret the sensor signals to receive the user input. The human interface unit 116 can include a light-based user input receiver, such as a camera or infrared receiver, a sound-based receiver, such as a microphone, a mechanical receiver, such as a keyboard, button, joystick, dial, or slider, a switch, a motion-based input, a touch-based input, or a combination thereof. Although FIG. 1 shows the human interface unit 116 as a single unit, multiple human interface units, or combinations of units, can be used.

The electronic device 200 can be a companion device to the wearable device 100. The companion device 200 can include a housing 202, an internal signal distribution medium 204, a power supply unit 206, a data storage unit 208, a data processing unit 210, a sensor unit 212, an electronic communication unit 214, and a human interface unit 216. The components of electronic device 200 can be substantially similar to, and can include some or all of the features of, the wearable device 100 discussed above. The companion device 200 can communicate with the wearable device 100 via communications link 215.

In some example, the companion device 200 can be a stationary, portable, and/or wearable computing device. In some examples, the companion device 200 can be a smartphone, tablet, laptop, smartwatch, or desktop computer. While the majority of the examples in the below disclosure relate to personal computing devices, it will be understood that the disclosed methods and systems can be implemented in any industry that utilizes user authentication and security, such as home or vehicle security systems. The companion device 200 can implement one or more aspects of the methods and systems described herein. It will be understood that the companion device 200 can include other components not shown in FIG. 1.

The sensors 112 and 212 of the wearable device 100 and the companion device 200, respectively, can include a vision system. The vision system can include one or more camera modules designed to capture images, which can include a two-dimensional rendering of an image. The vision system can further include a light emitting module designed to emit several light rays toward an object. The light rays can project a dot pattern onto the object. Further, the light emitting module can emit light in the frequency spectrum of invisible light, such as infrared light (or IR light). The vision system can further include an additional camera module designed to receive at least some of the light rays reflected from the object, and as a result, receive the dot pattern (from the light rays) projected onto the object and reflected by the object. The additional camera module can include a filter (such as an IR filter) designed to filter out light in that is not within the frequency spectrum of light emitted from the light emitting module. The additional camera module may provide this information (that is, the dot pattern) to a processor in the electronic device. The information can be used in conjunction with the image to determine an additional, third dimension of the object, and as a result, the vision system can assist in providing a three-dimensional rendering of the object.

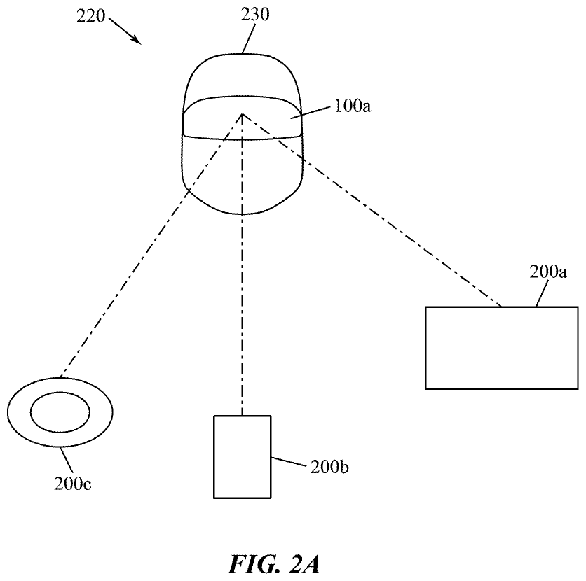

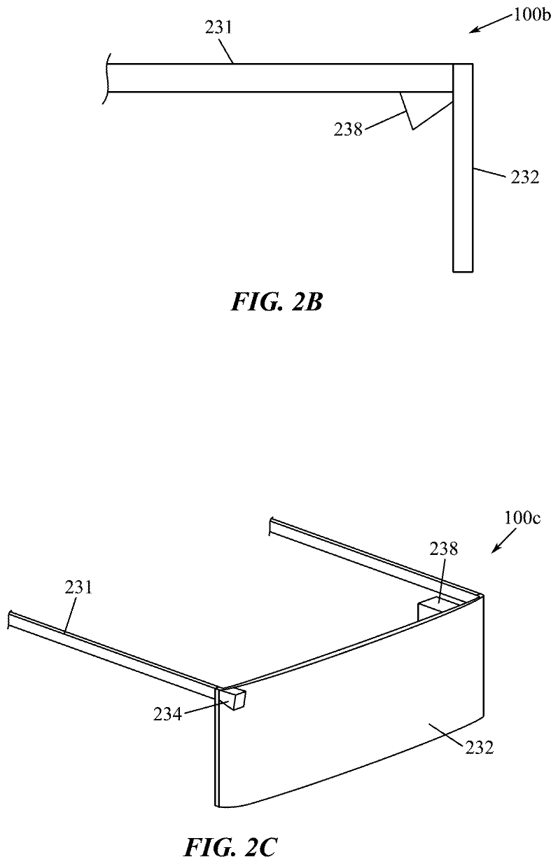

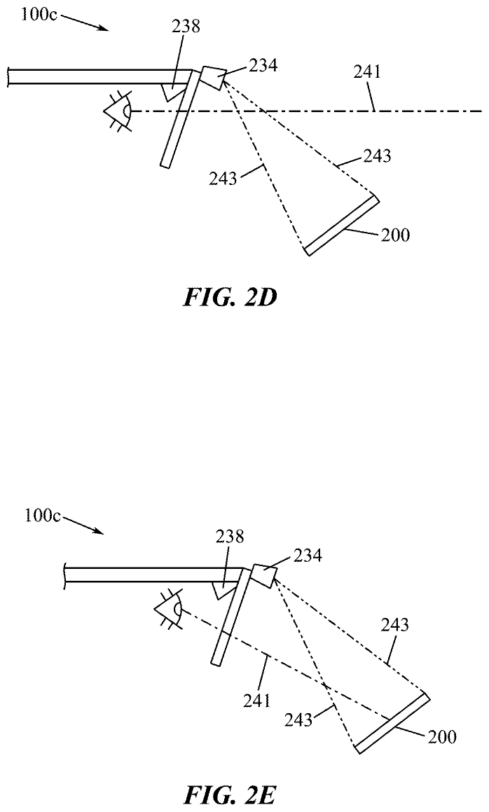

The light emitting module can be designed to emit light rays such that when the object is flat (resembling a two-dimensional object), the projected dot pattern resembles a “uniform” dot pattern in which the dots are equally spaced apart in rows and columns. However, when the object includes a three-dimensional object (such as a face), the projected dot pattern can include a “non-uniform” dot pattern in which a separation distance between some adjacent dots differs from a separate distance of other adjacent dots. The variation in separation distances between adjacent dots is the result of some features of the object being closer to the light emitting module, (and in particular, closer to the electronic device), as compared to other features, as adjacent dots projected onto relatively closer features of the object may be separated by a distance that is less than that of features of the object that are relatively further away. The relative separation distances of adjacent dots, along with a two-dimensional image of the object, can be used by the processor determine a third, additional dimension of the object such that a three-dimensional profile of the object is created. Further details of operational protocols between wearable and companion devices are provided below with reference to FIG. 2A.

FIG. 2A shows a block diagram of a system 220. The system 220 can include a head-mounted device 100a. In some examples, the head-mounted device 100a can be substantially similar to, and can include some or all of the features of, the wearable device 100 discussed above. The system 220 can include one or more secondary, companion, and/or proximate devices, such as a stationary user device 200a, a portable user device 200b, and/or a wrist-mounted wearable device 200c (collectively and individually referred to as companion device or proximate device 200). In some examples, the companion device 200 can be substantially similar to, and can include some or all of the features of, the companion device 200 discussed above with reference to FIG. 1. A user 230 is shown wearing the head-mounted device 100a.

The head-mounted device 100a can detect, monitor, or track one or more features or gestures of the user 230. For example, the head-mounted device 100a can include one or more sensors or human interface units for detecting, monitoring, or tracking one or more features or gestures of the user 230, such as head orientation, visual field (gaze) orientation, visual focal depth, head gestures, and/or hand or arm gestures. In some examples, the head-mounted device 100a can include an audio sensor (microphone) and can be operable to detect, monitor, or track commands spoken by the user 230. As discussed in greater detail below, the sensors of the head-mounted device 100a can be operable to detect, monitor, or track one or more aspects of the physical environment of the user 230, such as objects in the visual field of view of the user, including the companion device 200, and/or sound in the environment of the user.

In some examples, the sensors of the head-mounted device 100a, such as a vision system, can detect, monitor, or track one or more aspects of the environment of the head-mounted device 100a, such as the content in the visual field of a camera of the head-mounted device 100a.

As discussed in greater detail below, the head-mounted device 100a can authenticate the user 230 or verify the identity of the user 230. For example, the head-mounted device 100a can include one or more sensors to authenticate the user 230, such as biometric sensors. The head-mounted device 100a can include a locked state and an unlocked state. For example, in the unlocked state, a user can access otherwise restricted functions or content of the head-mounted device 100a. In some examples, the head-mounted device 100a can require an alpha-numerical passcode to unlock. In some examples, the head-mounted device 100a can be unlocked using biometric authentication, such as a fingerprint, eye, face, or voice recognition. In some examples, the head-mounted device 100a can be unlocked through an already authorized paired device, such as a smart watch, for example using the systems and methods discussed herein. In some examples, it may be necessary for the head-mounted device 100a to authenticate the user prior to transmitting a signal to the companion device 200. In some examples, it may be necessary for the head-mounted device 100a to be unlocked prior to provide user authentication credentials to a companion device, as discussed herein.

In some examples, the head-mounted device 100a can recognize when a user has removed the head-mounted device 100a. For example, the head-mounted device 100a can include one or more contact sensors, capacitive sensors, visual sensors, or the like, to determine that a user is wearing the head-mounted device 100a. The head-mounted device 100a can be programmed to assume a locked state upon determining that the user has removed the head-mounted device 100a. This feature can prevent an unauthorized user from accessing the authorized user's content merely by putting on the head-mounted device 100a after the authorized user.

The head-mounted device 100a can include one or more presentation or display units. For example, the head-mounted device 100a can include one or more presentation units operable to present or display audio or visual content to the user 230, such as in an augmented reality configuration, a mixed reality configuration, or a virtual reality configuration. In some examples, the head-mounted device 100a can include one or more presentation units operable to output one or more signals, such as an audio presentation, an ultrasound presentation, a visual presentation, an infrared presentation, or the like, to the environment of the user 230. For example, one or more presentation units of the head-mounted device 100a can be operable to output a presentation, such as a presentation of a quick-response (QR) code, a watermark, or an infrared signal to the user 230 or externally.

The head-mounted device 100a can communicate with an electronic communication network (not shown), such as via a wired or wireless electronic communication medium using an electronic communication protocol. The head-mounted device 100a can communicate with one or more external devices, such as one or more of the companion devices 200. For example, the head-mounted device 100a and the companion devices 200 can communicate by means of electronic communications similar to electronic communication 114 and 214 discussed above with reference to FIG. 1.

In some examples, the companion device 200 can include user authentication protocols and can verify the identity of the user 230 as an authenticated user. The companion device 200 can include a locked state and an unlocked state. For example, in the locked state, restricted-access functions of the companion device 200 can be inaccessible by the user, and in the unlocked state, a user can access the otherwise restricted functions or content of the companion device 200. In some examples, the companion device 200 can be accessed by an alpha-numerical passcode. In some examples, the companion device 200 can be unlocked using biometric authentication, such as facial, fingerprint, eye, face, or voice recognition. In some examples, the companion device 200 can be unlocked through an already authorized secondary device, such as a smart glasses, for example using the systems and methods discussed herein.

In some examples, the sensors of the companion device 200, such as a vision system, can detect, monitor, or track one or more aspects of the environment of the companion device 200, such as the content in the visual field of a camera of the companion device 200, sound in the environment of the companion device 200, or the like.

The companion device 200 can include one or more presentation or display units. For example, the companion device 200 can include one or more presentation units operable to present or display audio, visual, or both, content to the user 230. In some examples, the companion device 200 can include one or more presentation units operable to output one or more signals, such as an audio presentation, an ultrasound presentation, a visual presentation, an infrared presentation, or the like. For example, one or more presentation units of the companion device 200 may be operable to output a symbol or presentation, such as a presentation of a quick-response (QR) code, a watermark, or an infrared signal. Further details of head-mounted devices are provided below with reference to FIG. 2B.

FIG. 2B shows a side view of a head-mounted device or smart glasses 100b. The smart glasses 100b can be substantially similar to, and can include some or all of the features of, the wearable device 100 and the head-mounted device 100a discussed above. In some examples, the smart glasses 100b can include a frame or housing 231, one or more lenses 232, and a vision system, including a user-facing camera (UFC) 238. Although described as a user-facing camera, the UFC can include any camera or optical device that can capture an image of a user's face and/or eyes.

In some examples, the lens 232 includes an IR filter or blocker. The IR filter on the lens 232 can reflect or block infrared wavelengths while allowing visible light to pass through the lens. However, as discussed herein, an IR filter on the lens 232 can interfere with facial recognition of a companion device. For example, IR blocking eyewear can prevent a full analysis and match using facial recognition software, due to the system not being able to image the eyes and the surrounding area. Thus, an IR filter on the lens 232 can interfere with user authentication of a device when authentication is done through a facial recognition process. For example, an electronic device that utilizes facial recognition authentication may require a minimum threshold percentage match to unlock the device. An IR filter on eyewear may make it impossible to reach the minimum threshold match. Further, many facial recognition platforms require the user to be looking at the companion device to initiate an unlock sequence. However, if the user is wearing IR blocking eyewear, it may not be possible to determine the gaze of the user.

In some examples, the UFC 238 can be attached to or integrally formed with the frame 231 and/or lens 232. The UFC 238 can be positioned to obtain images of an eye of the user. In some examples, the UFC 238 can be positioned to obtain images of both eyes of the user. The smart glasses 100b can include multiple user-facing cameras, for example, two user-facing cameras, each positionable to obtain images of a respective eye of the user.

The smart glasses 100b can detect an orientation of a gaze of a user. For example, the smart glasses 100b can detect and track ocular characteristics, such as pupil location, glints, an orientation of the user's eye, or a gaze of the user based on a captured image obtained by the UFC 238, for example using computer vision. The gaze of the user can be established relative to an orientation of the smart glasses 100b or relative to a companion device.

Thus, in the case of a companion device being unable to authenticate a user through facial recognition due to IR blocking eyewear, the UFC 238 can supplement the facial recognition process of the companion device by determining a gaze of the user. Further details of smart glasses are provided below with reference to FIG. 2C.

FIG. 2C shows a perspective view of smart glasses 100c. The smart glasses 100c can be substantially similar to, and can include some or all of the features of, the wearable device 100, the head-mounted device 100a, and the smart glasses 100b discussed above. For example, the smart glasses 100c can include a frame 231, a lens 232, and a user-facing camera (UFC) 238. The smart glasses 100c can further include an outward facing camera (OFC) 234. The OFC 234 can be attached to or integrally formed with the frame 231 and/or lens 232. Although described as outward facing, the OFC 234 have any orientation or position to obtain images of the user's environment. For example, the OFC 234 can be positioned to obtain images that generally correspond to a field of view of the user. In some examples, the smart glasses 100c include multiple outward facing cameras. Further, in some examples, a single camera, such as a wide-angle camera, can operate as both a UFC and OFC.

The OFC 234 can include image recognition and tracking capabilities. The smart glasses 100c, by the OFC 234, can determine a location and/or orientation of an object relative to the smart glasses 100c. The OFC 234 and UFC 238 can be housed in separate and distinct housings. In some examples, the OFC 234 and UFC 238 can be formed in a single housing. Further details of the smart glasses 100c are provided below with reference to FIGS. 2D and 2E.

FIG. 2D shows example gaze and image tracking capabilities of the smart glasses 100c. Specifically, FIG. 2D illustrates an example in which the user is not looking at the companion device 200. In some examples, the OFC 234 and UFC 238 can activate in response to a companion device 200 being brought within a predetermined distance of the smart glasses 100c. For example, the smart glasses 100c and/or the companion device 200 can include proximity sensors that are programmed to transmit a signal in response to the companion device 200 being brought within less than 3 feet of the smart glasses 100c. In some examples, the OFC 234 and UFC 238 are configured to activate when it is determined or detected, by proximity sensors or any other suitable detection systems, that the companion device 200 and the smart glasses 100c are within a predetermined threshold distance of one another. In some examples, the predetermined threshold distance can be less than 1 foot apart, less than 3 feet apart, less than 5 feet apart, 10 feet apart, or less than 50 feet apart or more. In some examples, in response to determining, by proximity sensors, that the companion device 200 is within the predetermined distance from the smart glasses 100c, the OFC 234 and UFC 238 are activated. In some examples, the OFC 234 and/or UFC 238 are activated in response to receiving a signal that the user is attempting to unlock the companion device 200. For example, the OFC 234 and/or UFC 238 can activate in response to a vision system or facial recognition system of the companion device 200 at least partially recognizing a face. In some examples, the companion device 200 must establish at least a partial match (e.g., 40-80%) of the authorized user's face before signaling to the smart glasses 100c to activate the OFC 234 and/or UFC 238.

Once activated, the OFC 234 can locate the position of the companion device 200. In some examples, detecting a position of the companion device 200 includes using the OFC 234 to locate the companion device 200 in 3D space using video tracking (VIO) algorithms. In some examples, the location of the companion device 200 relative to the smart glasses 100c or user can be determined by the vision system of the companion device 200.

In order to ensure that the OFC 234 is looking at the correct device, the companion device 200 can display a unique background image or display a dynamic sync background. In some examples, to establish a “hand-shake” between the correct devices, one or more fiducial markers can be displayed on either the smart glasses 100c or companion device 200. The markers can be in the visible or non-visible spectrum, or pulsing light in a unique pattern, such that the devices can detect and recognize each other. In some examples, the smart glasses 100c can detect the companion device 200, or vice versa, in response to receiving a message or signal from using an electronic communication protocol, such as those discussed above with reference to FIG. 1.

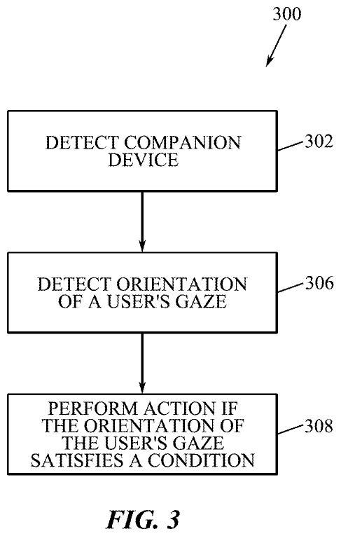

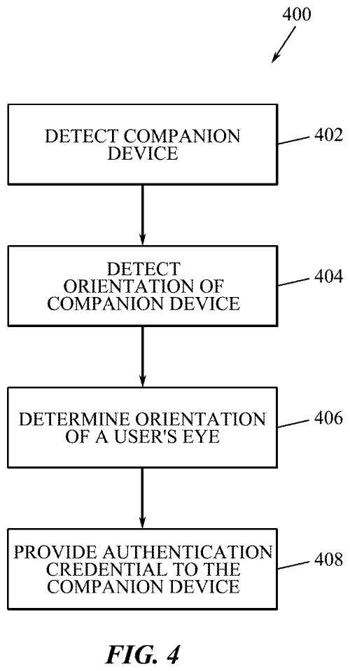

In some examples, an orientation of the companion device 200 can be determined by the OFC 234 or a vision system of the companion device. The orientation of the companion device 200 can refer to the relative position of one or more surfaces of the companion device 200 (i.e., the rotational position or the direction the companion device 200 is facing). A user's intent to access the companion device 200 can be determined from the orientation of the companion device 200 relative to the user or smart glasses 100c. For example, the smart glasses 100c can determine, by the OFC 234, that a display of the companion device 200, or a portion thereof, is visible to the user, such as within a defined offset range from a center of a line of sight of the user. In some examples, the smart glasses 100c can determine that the companion device 200 is spatially oriented outside the defined offset range (i.e., the display is not visible to the user), and the wearable device can thus determine an absence of user intent to access the companion device. Further details regarding detection of a companion device are provided below with reference to FIGS. 3 and 4.

Upon determining a location and/or orientation of the companion device 200 relative to the smart glasses 100c, represented by vectors 243, the gaze 241 of the user can be determined and compared with the vectors 243 to determine whether the orientation of the user's gaze 241 is directed at the companion device 200. The gaze 241 of the user can be determined using the UFC 238. In some examples, the gaze 241 is determined in response to the companion device 200 being within a predetermined proximity of the smart glasses 100c. In some examples, the smart glasses 100c can detect the orientation of the gaze when the companion device 200 recognizes the user's face via facial recognition software of the companion device 200. For example, the gaze 241 can be determined in response to the OFC 234 detecting the companion device or the vision system of the companion device at least partially recognizing the user's face. In some examples, the gaze 241 is continuously determined when the smart glasses 100c are in use, irrespective of the location of the companion device 200. Further details regarding determining an orientation of the user's eye are provided below with reference to FIGS. 3 and 4.

As described herein, various user authentication protocols may require that the user be looking at the device to unlock or to perform some action. Thus, in the example depicted in FIG. 2D, in which the gaze 241 is not directed at the companion device 200, the companion device 200 would not unlock.

FIG. 2E shows an example in which the user is looking at the companion device 200. In response to determining or detecting that the orientation of the user's gaze 241 is within a predetermined degree threshold of the location of the companion device 200, it can be determined that the user is looking at the companion device 200, indicating that the user desires to unlock the companion device 200. In some examples, the smart glasses 100c determine that the user is looking at the companion device 200 if the gaze 241 is within 5 degrees of any portion of the companion device 200. In some examples, the smart glasses 100c determine that the user is looking at the companion device 200 if the gaze 241 is within 1 degree of any portion of the companion device 200. In some examples, the system requires the gaze 241 of the user to be directed at the companion device 200 for a minimum duration of time before unlocking the companion device 200. This can prevent the companion device 200 from being unlocked due to a mere passing glance. In some examples, the gaze must be directed at the companion device 200 for more than 1 second before the user is considered to be looking at the companion device 200. In some examples, the gaze must be directed at the companion device 200 for more than 0.5 seconds before the user is considered to be looking at the companion device 200. In some examples, the system requires the gaze 241 of the user to stop or come to rest on the companion device 200 before unlocking the companion device. Further details regarding performing an action, such as providing authentication credentials to the companion device, are provided below with reference to FIGS. 3 and 4.

In some examples, information, such as authentication credentials can be provided to the companion device 200 in response to determining a location/orientation of the companion device (e.g., via the OFC 234 or proximity sensors) and determining that the companion device was previously paired with the smart glasses 100c. In other words, the gaze 241 of the user may not be determined and instead user authentication is based on detection of a paired companion device and a determination that a display of the companion device is visible to the user. The companion device 200 can also implement reduced facial recognition protocols in response to analyzing a face wearing paired smart glasses.

Any number or variety of components or devices in any configuration can be included in the systems for user authentication described herein. The systems, methods, and devices can include any combination of the features described herein, can be arranged in any of the various ways described herein, and can be performed or operated in any order, with some or all of any process steps carried out sequentially or in parallel. The structure, devices, steps, and processes of the systems and methods for user authentication described herein, as well as the concepts regarding characterization of sounds, can apply not only to the specific examples discussed herein, but to any number of embodiments in any combination. Various examples of methods for user authentication are described below, with reference to FIGS. 3 and 4.

FIG. 3 shows a flow diagram of an example process 300 for user authentication. The process 300 can be implemented between a primary device and a companion or proximate electronic device, such as between wearable device 100 and companion device 200 as shown in FIG. 1, between the head-mounted device 100a and companion devices 200a, 200b, and 200c shown in FIG. 2A, and between the smart glasses 100c and companion device 200 shown in FIGS. 2D and 2E.

At step 302, a companion device is detected. The companion device can be detected by an authenticated primary device, such as an authenticated wearable device. The detection of the companion device can occur as a result of a predefined proximity of the primary or wearable device and the companion device, such as within a predefined spatial distance, such as less than 50 feet, less than 10 feet, less than 3 feet, or within a line of sight.

The wearable device can detect the companion device in response to receiving a message or signal from the companion device using an electronic communication protocol, such as those discussed above with reference to FIG. 1. For example, the wearable device can receive a message or signal from the companion device using an electronic communication protocol indicating the proximity or presence of the companion device, and the wearable device can identify the companion device based on, or in response to, the received message or signal. The wearable device can receive the message or signal via a radio-based wireless electronic communication medium, such as wireless Ethernet, Bluetooth, or NFC. In some examples, the wearable device can receive the message or signal via a light-based electronic communication medium, such as infrared. The wearable device can receive the message or signal via a sound-based electronic communication medium, such as ultrasound. The wearable device can receive the message or signal via a human body conductivity-based electronic communication medium. In some examples, the wearable device can receive the message or signal in response to emitting a device proximity detection signal or message via the same or a different electronic communication medium.

In some examples, the wearable device can detect the companion device in response to analyzing data received from a sensor of the wearable device, such as the outward facing camera (OFC) 234 discussed above, which can capture one or more images of the environment of the wearable device. The wearable device can analyze the image, or images, to identify the content corresponding to the companion device and can identify a location and orientation of the companion device based on the image analysis and video tracking algorithms. In some examples, the companion device can be presenting a visual display that can be captured in one or more images captured by the camera of the wearable device, and the wearable device can detect the companion device based on image analysis identifying the visual display presented by the companion device.

In some examples, the wearable device can detect the companion device in response to receiving data from the companion device indicating a request to unlock the companion device. For example, a request to authenticate the companion device can result from facial recognition software on the companion device being activated and completing a partial match of the user's face, and the wearable device detects the companion device in response to the requested authentication on the companion device. In some examples, a request to authenticate the companion device can result from user input on the companion device, such as a button press or voice command, and the wearable device can detect the companion device in response to the user input.

At step 306, an orientation of the user's gaze is detected or determined, for example, using a user-facing camera as discussed above. In some examples, the orientation of the user's gaze can be detected in response to the companion device being detected, such as from a request to authenticate the companion device by facial recognition software on the companion device. By detecting or determining the orientation of the user's gaze, the wearable device can determine an intent of the user with respect to the companion device, for example an intent to unlock the companion device. The wearable device, by a user-facing camera, can determine or detect the orientation of the user's gaze based on one or more optical tracking metrics, such as pupil, iris, corneal tracking, gaze detection, and/or glint detection. The wearable device can also determine or detect the duration that the user's eye or gaze has been oriented in a particular way or a projected gaze path.

In some examples, the user-facing camera of the wearable device can determine an eye gesture. The wearable device can determine a user intent to access the companion device in response to detecting the eye gesture. In some examples, the eye gesture can be an expected response to a request for intent confirmation, such as request for intent confirmation output by the wearable device. One or more eye gestures, which can be user specific, indicating intent or consent, or the lack thereof, can be defined. For example, the wearable device can present a request for intent confirmation, such as audio or video output indicating “blink to unlock” and the wearable device can detect a blink by the user as an indication of user intent to access the companion device.

At step 308, an action is performed in response to determining that the orientation of the user's gaze satisfying a condition. The performed action can be authentication assistance of the companion device, such as transmitting information, including authentication credentials, to the companion device from the primary device. In some examples, a communication or transmission component of the primary or wearable device can be used to transmit the information, including authentication credentials to the companion or proximate device.

The condition satisfied by the orientation of the user's gaze can be that the user's gaze is directed at the companion device. In some examples, the condition can thus be based at least in part on a location of the companion or proximate device. In some examples, the condition can be whether the orientation of the user's gaze is within a predetermined degree threshold of the location of the companion or proximate device. In some examples, the condition can be based at least in part on whether the orientation of the user's gaze is within a predetermined degree threshold of the location of a display of the proximate or companion device.

In some examples, any of the steps 302, 306, 308 can be at least partially performed by a processor of the primary or wearable device. For example, a processor of the primary device can be configured to determine whether the orientation of the user's gaze satisfies a condition. In some examples, the processor can be configured to provide a signal in response to making such a determination. The processor can be in communication with one or more components of the primary device, and thus the action can be performed in response to the signal provided by the processor.

Performing the action can be dependent on the status of the companion device. For example, if the companion device is already in an unlocked state, the wearable device would not transmit the authentication credentials. Thus, performing authentication assistance can include performing a status determination of the companion device. Likewise, performing the action can be dependent on the status of the wearable device. For example, if the wearable device is in a locked state, the wearable device would not transmit the authentication credentials, regardless of the proximity of the companion device or the gaze direction of the user. In other words, performing any of the steps of process 300 can include performing a status determination of the wearable device. In some examples, performing the action can be based at least in part on the orientation or position of the proximate or companion device.

The status determination of the companion device can indicate that the companion device is in a locked state. The wearable device can receive a message or signal via an electronic communication protocol indicating that the companion device is receptive to receiving authentication data, such as a signal indicating that the companion device awaiting login or unlock information.

Once steps 302 and 306 have been completed, the wearable device can emit or transmit information, such as authentication data, via an electronic communication or transmission component, such as any of those discussed herein. The authentication data can include secure authentication credential data associated with the user. The secure authentication credential data can include information uniquely identifying the user or a user account associated with the user, such as a username, or a unique token associated with the user. The user identification data can be sent in secure or unsecure form. The secure authentication credential data can include user identity verification data, such as user password data or a token representing the user password data. The user identify verification data can be sent in secure form.

FIG. 4 shows a flow diagram of an example process 400 for user authentication. In some examples, the process 400 can be substantially similar to, and can include some or all of the steps or teachings of, the process 300 discussed above.

At step 402, a companion device is detected. Step 402 can be substantially similar to step 302 discussed above. For example, the companion device can be detected by a wearable device using any of the above-mentioned methods. In some examples, the detection of the companion device can occur as a result of the companion device being within a predefined spatial proximity of the primary or wearable device, as a result of the companion device receiving a request for access, or the wearable device detecting the companion device, such as by an outward facing camera. In some examples, the detection of the proximate, secondary, or companion device can include detecting a position, location, and/or orientation of the proximate, secondary, or companion device as described herein.

At step 404, an orientation of the companion device is detected. The orientation of the companion device can be detected or determined by a vision system of the primary or wearable device or a vision system of the companion device. A user's intent to access the companion device can be determined from the orientation of the companion device relative to the user. For example, the wearable device can determine, by an outward facing camera, that a display of the companion device, or a portion thereof visible to the user, such as within a defined offset range from a center of a line of sight of the user. In some examples, the wearable device can determine that the companion device is spatially oriented outside the defined offset range (i.e., the display is not visible to the user), and the wearable device can thus determine an absence of user intent to access the companion device.

The orientation of the companion device can be detected or determined using an outward facing camera, such as OFC 234 of FIGS. 2D and 2E, of the wearable device and/or a vision system of the companion device. The OFC can determine the orientation of the companion device using computer vision and VIO algorithms. In some examples, a symbol or indicia can be displayed on the companion device to aid the OFC in determining the orientation of the companion device. In some examples, the orientation of the companion device can be determined based on an indication that the facial recognition software of the companion device has detected the user's face and is in the process of identifying the user's face. The orientation of the companion device can be determined relative to the wearable device, a gravitational direction, or the user's face.

The wearable device or the companion device can determine a temporal duration of the orientation of the companion device. In other words, the system can determine how long the companion device has been in a particular orientation or whether the orientation of the companion device is dynamically changing and at what rate. For example, the wearable device can track the spatial orientation of the companion device and can determine that variations in the spatial orientation of the companion device with are below a defined maximum spatial variation threshold for a temporal duration, and the wearable device can determine the user intends to access the companion device in response to the determination that the variations in the spatial orientation of the companion device with respect to the user are below the defined maximum spatial variation threshold for a temporal duration.

At step 406, an orientation of the user's gaze is detected or determined. Step 406 can be substantially similar to step 306 of FIG. 3. By determining or detecting the orientation of the user's gaze, the wearable device, such as a processor thereof, can determine whether the user's gaze satisfies a condition. For example, a processor of the wearable device can determine whether the orientation of the user's gaze is within a predetermined degree threshold of the companion device and/or a display of the companion device. That is, the primary or wearable device can determine that the user is looking at the companion device and therefore infer an intent of the user with respect to the companion device, for example an intent to unlock the companion device. The wearable device can, by the user-facing camera, detect or determine the orientation of the user's gaze based on one or more optical tracking metrics, such as tracking of the pupil, iris, cornea, gaze, and/or glint. The wearable device can also determine the duration that the user's eye has been orientation in a particular way or projected gaze trajectory.

At step 408, authentication credentials are provided to the companion device from the primary or wearable device based at least in part on whether the detected orientation of the user's gaze satisfies a condition. Step 408 can be substantially similar to step 308 of FIG. 3. In response to detecting the companion device, determining that an orientation of the companion device is consistent with an intent to access the companion device, and determining that an orientation of the user's eye is consistent with the user looking at the companion device, the wearable device can emit, transmit, or provide information, for example including authentication credentials, via an electronic communication or transmission component, such as any of those discussed herein. The authentication data can include secure authentication credential data associated with the user. The secure authentication credential data can include information uniquely identifying the user or a user account associated with the user, such as a username, or a unique token associated with the user. The user identification data can be sent in secure or unsecure form. The secure authentication credential data can include user identity verification data, such as user password data or a token representing the user password data. The user identify verification data can be sent in secure form.

In some examples, any of the steps 402, 404, 406, 408 can be at least partially performed by a processor of the primary or wearable device. For example, a processor of the primary device can be configured to determine whether the orientation of the user's gaze satisfies a condition. In some examples, the processor can be configured to provide a signal in response to making such a determination. The processor can be in communication with one or more components of the primary device, and thus the action can be performed in response to the signal provided by the processor.

Using the systems, methods, and processes discussed above, a vision system of a wearable device can enable user authentication of a companion device requiring facial recognition and gaze determination access, even when the user's eyes are blocked from IR light.

As used herein, a physical environment can include a physical world that can be sensed or interacted with without electronic systems. A computer-generated reality, in contrast, can include a simulated environment, to any degree, that people sense and/or interact with using an electronic system, including virtual reality and mixed reality. Similarly, virtual reality can refer to a simulated environment that is designed to be based entirely on computer-generated sensory inputs for one or more senses. In contrast, mixed reality environments refer to a simulated environment that is designed to incorporate sensory inputs from the physical environment, or a representation thereof, in addition to including virtual objects. These environments can be generated using any number of hardware components including, but in no way limited to, head mounted systems, projection-based systems, heads-up displays, mobile phones, windshields with integrated displays, speakers, headphones, tablets, laptop computers, monitors, televisions, displays of all types, and the like.

Personal information data can be used to implement and improve on the various embodiments described herein, and should be gathered pursuant to authorized and well established secure privacy policies and practices that are appropriate for the type of data collected. The disclosed technology is not, however, rendered inoperable in the absence of such personal information data.

It will be understood that the details of the present systems and methods above can be combined in various combinations and with alternative components. The scope of the present systems and methods will be further understood by the following claims.

What is claimed is:

1. A system for user authentication, the system comprising:
a wearable device configured to:
detect an orientation of a gaze of a user;
determine whether the orientation of the gaze satisfies a condition based at least in part on a location of a companion device; and
transmit a signal to the companion device in response to determining that the orientation of the gaze satisfies the condition.

2. The system of claim 1, wherein:
the orientation of the gaze comprises a direction the user is looking;
the condition comprises the orientation of the gaze being within one degree of the location of the companion device; and
the signal comprises authentication credentials to access the companion device.

3. The system of claim 1, wherein:
the companion device has a locked state and an unlocked state; and
the signal comprises authentication credentials to change the companion device from the locked state to the unlocked state.

4. The system of claim 3, wherein:
a restricted-access function of the companion device is inaccessible by the user in the locked state; and
the restricted-access function of the companion device is accessible by the user in the unlocked state.

5. The system of claim 1, wherein:
the wearable device comprises a camera configured to capture an image of the user's eye; and
the wearable device determines whether the orientation of the gaze satisfies the condition based at least in part on the captured image.

6. The system of claim 5, wherein:
the camera is a first camera and the wearable device comprises a second camera configured to determine an orientation of the companion device; and
the wearable device determines whether the orientation of the gaze satisfies the condition based at least in part on the orientation of the companion device.

7. The system of claim 1, wherein the wearable device comprises a proximity sensor to detect the location of the companion device.

8. The system of claim 1, wherein the wearable device is configured to authenticate the user prior to transmitting the signal to the companion device.

9. The system of claim 1, wherein:
the companion device comprises a facial recognition system configured to recognize a user's face; and
the wearable device is configured to detect the orientation of the gaze when the companion device recognizes the user's face.

10. The system of claim 1, wherein the wearable device comprises a head-mounted device.

11. A wearable device comprising:
a user-facing camera configured to detect an eye pose of a user;
a processor in communication with the user-facing camera, the processor configured to
determine whether the user is looking at a proximate device based at least in part on the eye pose; and
a transmission component in communication with the processor, the transmission component configured to transmit authentication credentials to the proximate device in response to determining that the user is looking at the proximate device.

12. The wearable device of claim 11, further comprising an outward-facing camera configured to detect a location of the proximate device.

13. The wearable device of claim 11, wherein the processor is further configured to:
determine whether a display of the proximate device is facing the user's eye; and
provide a signal in response to determining that the user is looking at the proximate device and that the display of the proximate device is facing the user's eye.

14. The wearable device of claim 11, wherein the wearable device comprises a head-mounted device comprising an infrared protective lens.

15. A method for user authentication, the method comprising:
detecting a gaze direction of a user by a primary device;
detecting a position of a secondary device;
providing a signal from the primary device to the secondary device in response to determining that the gaze direction is oriented toward the position of the secondary device.

16. The method of claim 15, wherein detecting the position of the secondary device comprises detecting an orientation of the secondary device.

17. The method of claim 15, wherein the signal comprises authentication credentials.

18. The method of claim 15, wherein detecting the position of the secondary device comprises detecting that the secondary device is within a predetermined threshold distance from the primary device.

19. The method of claim 15, wherein the gaze direction is determined to be oriented toward the position of the secondary device when the gaze direction is within one degree of any portion of the secondary device.

20. The method of claim 15, wherein detecting the position of the secondary device comprises:
displaying a symbol on the secondary device; and
detecting the symbol with the primary device.
